(19) United States
(12) Patent Application Publication
(10) Pub. No.: US 2015/0262574 A1
(43) Pub. Date: Sep. 17, 2015

(54) EXPRESSION CLASSIFICATION DEVICE, EXPRESSION CLASSIFICATION METHOD, DISSATISFACTION DETECTION DEVICE, DISSATISFACTION DETECTION METHOD, AND MEDIUM

(71) Applicants: Makoto TERAO, (US); Yoshifumi ONISHI, (US); Koji OKABE, (US); Masahiro TANI, (US)

(72) Inventors: Makoto Terao, Tokyo (JP); Yoshifumi Onishi, Tokyo (JP); Koji Okabe, Tokyo (JP); Masahiro Tani, Tokyo (JP)

(73) Assignee: NEC Corporation, Minato-ku, Tokyo (JP)

(21) Appl. No.: 14/438,661

(22) PCT Filed: Sep. 19, 2013
(86) PCT No.: PCT/JP2013/075244

§ 371 Date: Apr. 27, 2015

(30) Foreign Application Priority Data
Oct. 31, 2012 (JP) 2012-240765

(51) Int. Cl. G10L 15/08

(52) U.S. Cl. CPC G10L 15/08

(57) ABSTRACT

An expression classification device includes: a segment detection unit that detects a specific expression segment that includes a specific expression that can be used in a plurality of nuances from data corresponding to a voice of a conversation; a feature extraction unit that extracts feature information that includes at least one of a prosody feature and an utterance timing feature with regard to the specific expression segment that is detected by the segment detection unit; and a classification unit that classifies the specific expression included in the specific expression segment based on a nuance corresponding to a use situation in the conversation by using the feature information extracted by the feature extraction unit.

### TECHNICAL FIELD

The present invention relates to a conversation analysis technique.

### BACKGROUND ART

As an example of a technique of analyzing a conversation, there is a technique of analyzing telephone conversation data. For example, data of telephone conversations that takes place at a section called a call center, a contact center or the like is analyzed. Hereinafter, a section that specializes in such business of answering telephone calls from customers concerning inquiries, complaints, and orders with regard to the products and services, is referred to as a contact center.

Voices from customers that are collected at a contact center often reflect customer needs and satisfaction, and therefore, extracting such customer emotions and needs from telephone conversations with customers is significantly important for companies in order to increase regular customers. Accordingly, a variety of methods of extracting customer emotions (anger, irritation, unpleasantness, and the like) by analyzing the voices of telephone conversations have been proposed.

For enhancement of performance in case of detecting customers' excitement (complaints), the following PLT 1 proposes a method of detecting, as a complaint detection evaluation value, response time that is acquired from a difference between the operator's response utterance start time and receiving call start time, and determining that the operator is handling a complaint when the complaint detection evaluation value is equal to or less than a threshold. The following PLT 2 proposes a method of monitoring operators' reception contents to a customer in answering telephone call by a computer, and determining whether the telephone call is a complaint based on a condition of: the loudness of the customer's voice, a condition of whether frequency of appearance of complaint terms in the words spoken by a customer is high or low, a condition of whether frequency of appearance of apologetic terms in the words spoken by an operator is high or low, and whether the operator is at a loss for words or not. The following PLT 3 proposes a method of detecting strained voices by fundamental frequency analysis, modulation frequency analysis, and the like.

### CITATION LIST

### Patent Literature

[PLT 1] Japanese Unexamined Patent Application Publication No. 2007-286097

[PLT 2] Japanese Unexamined Patent Application Publication No. 2008-167226

[PLT 3] Japanese Unexamined Patent Application Publication No. 2009-3162

### SUMMARY OF INVENTION

### Technical Problem

However, the above proposed methods may not be able to appropriately extract emotional states of people who join a conversation (hereinafter, referred to as conversation participants). This is because the above proposed methods do not consider at all nuances of specific expressions that are uttered by the conversation participants.

For example, the proposed methods of the above PLT 1 and PLT 2 detect responses and apologetic terms of an operator and complaint terms of a customer, and estimate the complaint states of the customer from these word expressions. However, although the exact same words of the response expressions, apologetic expressions and complaint expressions may be used, they may be used in a plurality of nuances. For example, an apologetic expression “moushiwake gozaimasen (I am sorry.)” may be uttered with apologetic sense for causing inconvenience to the customer or perfunctorily uttered such as in “moushiwake gozaimasen ga, shoushou omachikudasai (I am sorry, but please hold a moment.)”. Further, response expressions such as “hai (Yes)” and “ee (Uh-huh)” may be used in a plurality of completely different connotations, including cases of expressing complaints and cases of expressing apology. The proposed method of PLT 3 does not focus on individual expressions themselves.

The present invention is achieved in consideration of such problems and provides a technique of appropriately classifying specific expressions that are uttered in conversations in accordance with nuances corresponding to a use situation. Here, the specific expression means at least a part of an expression (words) that can be used in a plurality of nuances, and the nuance means a subtle difference, such as the emotional state or connotation embodied in the specific expression and the intention of using the specific expression.

### Solution to Problem

In order to solve the above problems, the modes of the present invention respectively employ the following components.

A first mode relates to an expression classification device. The expression classification device according to the first mode includes: a segment detection unit that detects a specific expression segment that includes a specific expression that can be used in a plurality of nuances from data corresponding to a voice of a conversation; a feature extraction unit that extracts feature information that includes at least one of a prosody feature and an utterance timing feature with regard to the specific expression segment that is detected by the segment detection unit; and a classification unit that classifies the specific expression included in the specific expression segment based on a nuance corresponding to a use situation in the conversation by using the feature information extracted by the feature extraction unit.

A second mode relates to an expression classification method that is executed by at least one computer. The expression classification method according to the second mode includes: detecting a specific expression segment that includes a specific expression that can be used in a plurality of nuances from data corresponding to a voice of a conversation; extracting feature information that includes at least one of a prosody feature and an utterance timing feature with regard to the detected specific expression segment; and classifying the specific expression included in the specific expression segment based on a nuance corresponding to a use situation in the conversation by using the extracted feature information.

Another mode of the present invention may be a dissatisfaction detection device includes: an expression classification device according to the above first mode; and a dissatisfaction determination unit that determines a conversation that includes an apologetic expression or an response expression as a dissatisfaction conversation when the apologetic expression is classified as sincere apology or the response expression is classified as including a dissatisfactory emotion or an apologetic emotion by the classification unit of the expression classification device. Further, another mode may be a dissatisfaction detection method that includes: executing the expression classification method according to the above second mode by at least one computer; and further determining a conversation that includes an apologetic expression or an response expression as a dissatisfaction conversation when the apologetic expression is classified as sincere apology or the response expression is classified as including a dissatisfactory emotion or an apologetic emotion. Further, another mode of the present invention may be a program that causes at least one computer to execute each of the components of the first mode, or a computer-readable recording medium that stores such the program. This recording medium includes a non-transitory tangible medium.

### Advantageous Effects of Invention

According to the above modes, the present invention can provide a technique that can appropriately classify a specific expression that is uttered in conversations in accordance with a nuance corresponding to a use situation.

### BRIEF DESCRIPTION OF DRAWINGS

The above-described objects, and other objects, features, and advantages will be further clarified with the preferred exemplary embodiments described below and the following appended drawings.

FIG. 1 A conceptual diagram illustrating a configuration example of a contact center system in a first exemplary embodiment;

FIG. 2 a diagram conceptually illustrating a processing configuration example of a telephone analysis server in the first exemplary embodiment;

FIG. 3A a diagram conceptually illustrating an example of an utterance timing feature;

FIG. 3B a diagram conceptually illustrating an example of an utterance timing feature;

FIG. 4 a flowchart illustrating an operation example of the telephone analysis server according to the first exemplary embodiment;

FIG. 5 a diagram conceptually illustrating a processing configuration example of a telephone analysis server in a second exemplary embodiment; and

FIG. 6 a flowchart illustrating an operation example of the telephone analysis server in the second exemplary embodiment.

### DESCRIPTION OF EMBODIMENTS

In the following, exemplary embodiments of the present invention will be described. The exemplary embodiments listed below are examples, and the present invention will not be limited to the components of the following exemplary embodiments.

The expression classification device according to the exemplary embodiments includes: a segment detection unit that detects a specific expression segment that includes a specific expression that can be used in a plurality of nuances from data corresponding to a voice of a conversation; a feature extraction unit that extracts feature information that includes at least one of a prosody feature and an utterance timing feature with regard to the specific expression segment that is detected by the segment detection unit; and a classification unit that classifies the specific expression included in the specific expression segment based on a nuance corresponding to a use situation in the conversation by using the feature information extracted by the feature extraction unit.

The expression classification method according to the exemplary embodiments that is executed by at least one computer, includes: detecting a specific expression segment that includes a specific expression that can be used in a plurality of nuances from data corresponding to a voice of a conversation; extracting feature information that includes at least one of a prosody feature and an utterance timing feature with regard to the detected specific expression segment; and classifying the specific expression included in the specific expression segment based on a nuance corresponding to the use situation in the conversation by using the extracted feature information.

Here, the conversation means a talk in which two or more speakers express intentions by utterance of words and the like. The conversation may take a form in which conversation participants directly talk to each other, such as at a teller counter of a bank or at a cash register of a store, or a form in which conversation participants at distant locations from each other talk, such as in a telephone conversation or in a video conference by using telephone devices. The exemplary embodiments do not restrict the contents and forms of the target conversations.

In the exemplary embodiments, a specific expression segment is detected from the data corresponding to a voice of a conversation. The data corresponding to the voice includes voice data and data other than the voice that is obtained by processing the voice data. The specific expression included in the specific expression segment means at least a part of expressions (words) that can be used in a plurality of nuances as described above. There are a variety of words for such words, for example, apologetic expressions, appreciative expressions, response expressions, and interjections. For example, a phrase such as “nani o iu (what are you talking about?)” is included in the specific expressions and wording used in a plurality of nuances, such as anger, embarrassment, or disgust, depending on how it is used. Further, even a word may be used in a plurality of nuances. Furthermore, as the specific expressions are at least a part of such word expressions, the specific expressions may be “arigatou (thank you)” as a word, “arigatou (thank you)”, “gozai (politeness suffix)”, and “masu (politeness suffix)” as a word string or “hontou (really)” and “arigatou (thank you)” as a word set.

In the exemplary embodiments, feature information that includes at least one of a prosody feature and an utterance timing feature with regard to a specific expression segment is extracted. The prosody feature is feature information relating to the voice of a specific expression segment in a conversation. For example, a fundamental frequency, speech power, speech speed and the like are used as prosody information. The utterance timing feature is information relating to the utterance timing of the specific expression segment in the conversation. For example, elapsed time from an utterance of the other conversation participant just before a specific expression segment to the specific expression segment is used as an utterance timing feature.

The same expression “moushiwake arimasen (I am sorry)” comes different in, such as the prosody of the voice, a change therein, and even the utterance timing between a case in which it is uttered with compassion for dissatisfaction of the other participant and a case in which it is perfunctorily uttered. For example, when apologizing for the dissatisfaction of the other participant, phenomena such as the voice tone becoming monotonous (a prosody feature) or an apologetic expression being stated immediately after the utterance of the customer (an utterance timing feature) are observed.

Thus, in the exemplary embodiments, by using at least one of the prosody feature and utterance timing feature as feature information, a specific expression included in a specific expression segment is classified in accordance with a nuance corresponding to a use situation in a conversation. Classification of a specific expression using the feature information as a feature can be realized by a variety of statistical classification methods called classifiers. While an example of the methods will be described later in the detailed exemplary embodiments, known statistical classification methods, such as a linear identification model, a logistic regression model, an SVM (Support Vector Machine), may be used to realize the classification.

In this way, the exemplary embodiments can improve the classification accuracy because of focusing a target on a specific expression that can be used in a plurality of nuances among a plurality of expressions included in a conversation, and further focusing a feature used in the classification on feature information that can be obtained from a specific expression segment that includes the specific expression. Therefore, according to the exemplary embodiments, a specific expression that is uttered in a conversation can be appropriately classified based on a nuance corresponding to a use situation. Further, according to the exemplary embodiments, because the emotional state and connotation embodied in the specific expression and the use intention of the specific expression can be taken into account by using the classification result based on the nuance of the specific expression, the emotional states of the conversation participants in the target conversation can be estimated with high accuracy.

Hereinafter, the above-described exemplary embodiments will be further described. In the following, a first exemplary embodiment and a second exemplary embodiment will be exemplified as detailed exemplary embodiments. The following respective exemplary embodiments are examples of a case in which the above-described expression classification device and expression classification method are adapted in a contact center system. The above-described expression classification device and expression classification method can be applied in a variety of modes that deal with conversation data without limiting to application to contact center systems that deal with telephone conversation data. For example, the expression classification device and the expression classification method can be applied in an in-house telephone management system in other sections than a contact center, or a telephone terminal owned by individuals, such as a PC (Personal Computer), a fixed telephone set, a portable telephone, a tablet terminal, and a smartphone. Further, as conversation data, for example, data of a conversation between staff and a customer at a teller counter of a bank or at a cash register of a store may be used.

Hereinafter, a telephone conversation used in the respective exemplary embodiments means a call, from when the telephone terminals that are respectively owned by a telephone conversation participant and another telephone conversation participant are connected to when the telephone terminals are disconnected. Further, among the voices of a telephone conversation, a continuous region where a single conversation participant is uttering a voice is referred to as an utterance or an utterance segment. For example, the utterance segment is detected as a segment in which amplitude of not less than a predetermined value continues in a speech waveform of a telephone conversation participant. A normal telephone conversation is formed by utterance segments of respective telephone conversation participants, silent segments and the like.

### First Exemplary Embodiment

### System Configuration

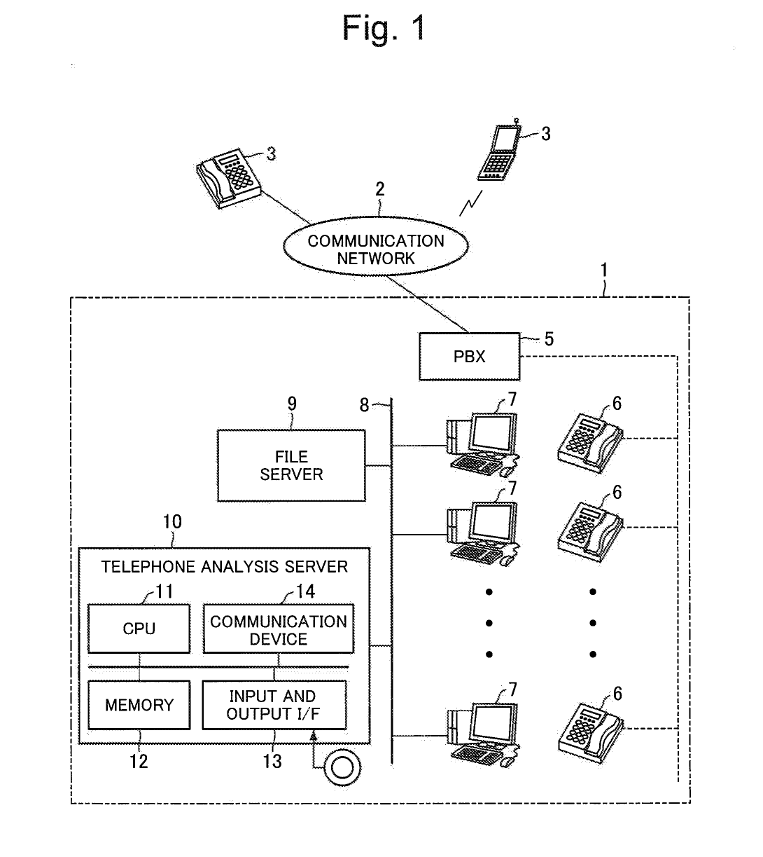

FIG. 1 is a conceptual diagram illustrating a configuration example of a contact center system 1 according to the first exemplary embodiment. The contact center system 1 according to the first exemplary embodiment includes a Private Branch eXchange (PBX) 5, a plurality of operator telephone sets 6, a plurality of operator terminals 7, a file server 9, a telephone analysis server 10, and the like. The telephone analysis server 10 includes a component that is equivalent to the expression classification device in the above-described exemplary embodiments.

The PBX 5 is communicably connected with a telephone terminal (customer telephone set) 3, such as a PC, a fixed telephone set, a portable telephone, a tablet terminal, and a smartphone, that are used by customers, via a communication network 2. The communication network 2 is a public network, a wireless communication network, and the like, such as Internet and a PSTN (Public Switched Telephone Network). The PBX 5 is respectively connected with the each operator telephone set 6 that is used by each operator in a contact center. The PBX 5 receives a call from a customer and connects the call to the operator telephone set 6 of an operator corresponding to the call.

Each operator respectively uses an operator terminal 7. Each operator terminal 7 is a general purpose computer, such as a PC, that is connected to a communication network 8 (e.g., LAN (Local Area Network)) in the contact center system 1. For example, each operator terminal 7 respectively records the voice data of a customer and the voice data of an operator in a telephone conversation between the each operator and the customer. The voice data of the customer and the voice data of the operator may be generated by being separated from the mixed state through predetermined voice processing. The exemplary embodiment does not restrict the recording methods and recording subjects of such voice data. Each voice data may be generated by other device (not illustrated) other than the operator terminal 7.

The file server 9 is implemented by a general server computer. The file server 9 respectively stores telephone conversation data of each telephone conversation between a customer and an operator together with the identification information of each telephone conversation. Each telephone conversation data includes a pair of the voice data of a customer and the voice data of an operator and disconnect time data that indicates time when the telephone conversation is disconnected. The file server 9 acquires the voice data of the customer and the voice data of the operator from other devices (e.g., the each operator terminal 7) that records each voice of the customer and operator.

The telephone analysis server 10 respectively analyzes each telephone conversation data stored in the file server 9. The telephone analysis server 10 respectively estimates the emotional state of each telephone conversation participant.

The telephone analysis server 10, as illustrated in FIG. 1, includes a CPU (Central Processing Unit) 11, a memory 12, an input and output interface (I/F) 13, a communication device 14 and the like as hardware components. The memory 12 is a RAM (Random Access Memory), a ROM (Read Only Memory), a hard disk, a portable recording medium, or the like. The input and output I/F 13 is connected with a device that accepts inputs from user operation, such as a keyboard, a mouse, and the like, and a device that provides information to a user, such as a display device, a printer, and the like. The communication device 14 communicates with a file server 9 and the like via a communication network 8. There is no restriction on the hardware configuration of the telephone analysis server 10.

[Processing Configuration]

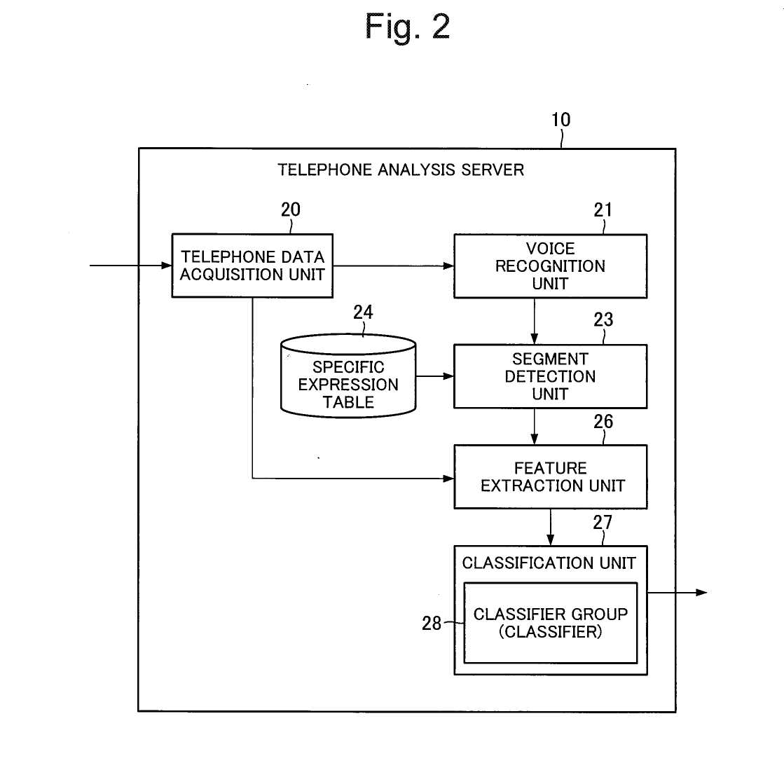

FIG. 2 is a diagram conceptually illustrating a processing configuration example of the telephone analysis server 10 according to the first exemplary embodiment. The telephone analysis server 10 according to the first exemplary embodiment includes a telephone data acquisition unit 20, a voice recognition unit 21, a segment detection unit 23, a specific expression table 24, a feature extraction unit 26, a classification unit 27 and the like. These each processing unit is respectively implemented by the CPU 11 executing a program stored in the memory 12. Further, the program may be installed via the input and output I/F 13 from a portable recording medium, such as a CD (Compact Disc), a memory card or the like, or other computer on a network, and is stored in the memory 12.

The telephone data acquisition unit 20 acquires the telephone conversation data of a telephone conversation that is an analysis target with the identification information of the telephone conversation from the file server 9. The telephone conversation data may be acquired by means of a communication between the telephone analysis server 10 and the file server 9 or acquired via a portable recording medium.

The voice recognition unit 21 performs voice recognition processing for respective voice data of the operator and the customer included in the telephone conversation data. Accordingly, the voice recognition unit 21 acquires respective voice text data and respective utterance time data which are corresponding to the operator speech and customer speech from the telephone conversation data respectively. Here, the voice text data is text data that is converted the voice uttered by the customer or operator into text data. Each voice text data is divided into words (parts of speech). Each utterance time data includes utterance time data for each word of the voice text data.

The voice recognition unit 21 may detect each of the utterance segments of the operator and the customer from the respective voice data of the operator and the customer, and acquire the start time and the end time of each utterance segment. In such a case, the voice recognition unit 21 may determine utterance time for each word string that corresponds to each utterance segment in each voice text data, and define the utterance time for each word string that corresponds to each utterance segment as the above-described utterance time data. In the exemplary embodiment, a known method may be used for the voice recognition processing of the voice recognition unit 21. There is no restriction on the voice recognition processing and the voice recognition parameters that are used in the voice recognition processing. In the exemplary embodiment, there is also no restriction on the method of detecting utterance segment.

The voice recognition unit 21 may perform voice recognition processing only for voice data of either a customer or an operator in accordance with the specific expressions that will be the classification targets in the classification unit 27. For example, when apologetic expressions of an operator are classification targets, the voice recognition unit 21 may perform voice recognition processing only for voice data of the operator.

The specific expression table 24 stores a specific expression that is the classification target of the classification unit 27. Specifically, the specific expression table 24 stores at least one specific expression that has the same concept. Here, the same concept means that the general implication that each of the specific expressions has is the same. For example, the specific expression table 24 stores specific expressions that have apologetic meaning such as “moushiwake (sorry)”, “sumimasen (I apologize)”, and “gomenasai (excuse me)”. Hereinafter, a set of specific expressions that have the same concept may be referred to as a specific expression set. However, there is a case in which the specific expression set is configured by only a single specific expression.

Further, there is a case in which the specific expression table 24 stores a plurality of specific expression sets that have different concepts in such a manner that the specific expression sets are distinguishable. In addition to the specific expression set that indicates apology as described above, the specific expression table 24 may store, for example, a specific expression set that indicates appreciation, a specific expression set that indicates response, and specific expression sets that indicate emotions such as anger and impression. In such a case, the respective specific expressions are stored in units of apologetic expressions, appreciative expressions, response expressions, and impressive expressions in such a manner that the expressions are distinguishable. The specific expression set that indicates appreciation may include, for example, a specific expression such as “arigatou (thank you)”. The specific expression set that indicates response expressions includes specific expressions such as “ee (Uh-huh)” and “hai (Yes)”.

The segment detection unit 23 detects the specific expression stored in the specific expression table 24 from among the voice text data acquired by the voice recognition unit 21, and detects the specific expression segment that includes the detected specific expression. For example, when the specific expression is “moushiwake (sorry)” and the utterance segment is “moushiwake gozai masen (I am sorry)”, the segment corresponding to “moushiwake (sorry)” in the utterance segment is detected as a specific expression segment. However, the detected specific expression segment may agree with the utterance segment. The segment detection unit 23 acquires the start time and end time of the specific expression segment by this detection.

The feature extraction unit 26 extracts feature information that includes at least one of a prosody feature and an utterance timing feature with regard to the specific expression segment that is detected by the segment detection unit 23. A prosody feature is extracted from the voice data of the specific expression segment. As the prosody feature, for example, a fundamental frequency (F0), power, speech speed, and the like are used. Specifically, for each frame of a predetermined time width, the fundamental frequency, power, and the variation thereof (Δ) are calculated, and the maximum value, minimum value, mean value, variance value, range, and the like within the specific expression segment are calculated as the prosody feature. The continuous time length of each phoneme within the specific expression segment, the continuous time length of the whole specific expression segment, and the like are calculated as the prosody feature with regard to the speech speed. A known method may be used for the method of extracting such the prosody feature from the voice data.

The feature extraction unit 26 extracts the elapsed time from the end time of an utterance of the other telephone conversation participant just before the specific expression segment to the start time of the specific expression segment as an utterance timing feature. The elapsed time is, for example, calculated by using the utterance time data acquired by the voice recognition unit 21.

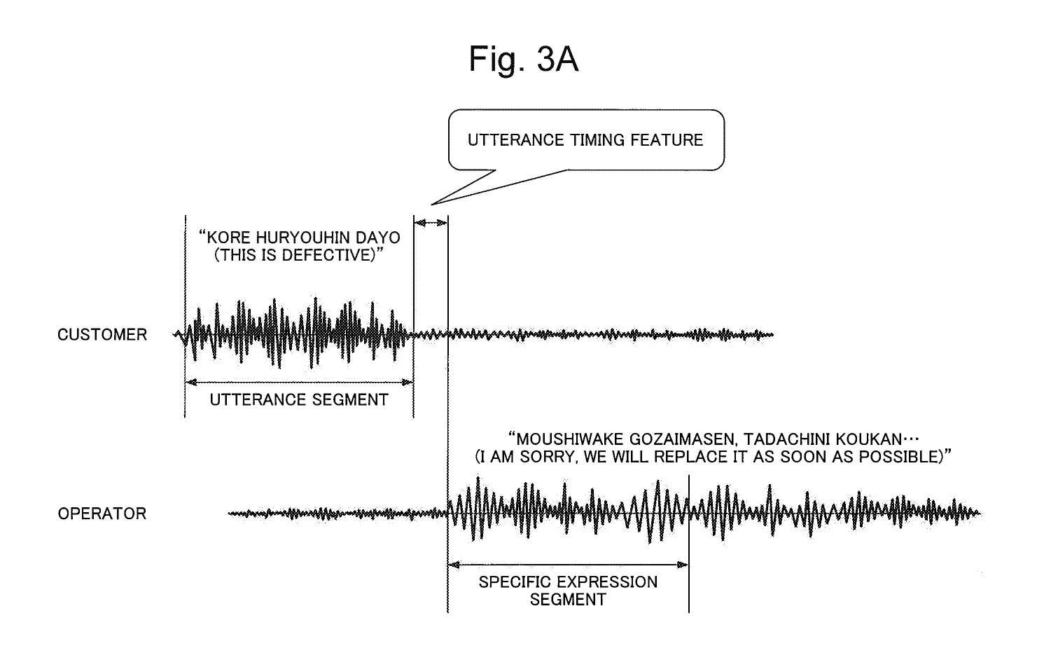

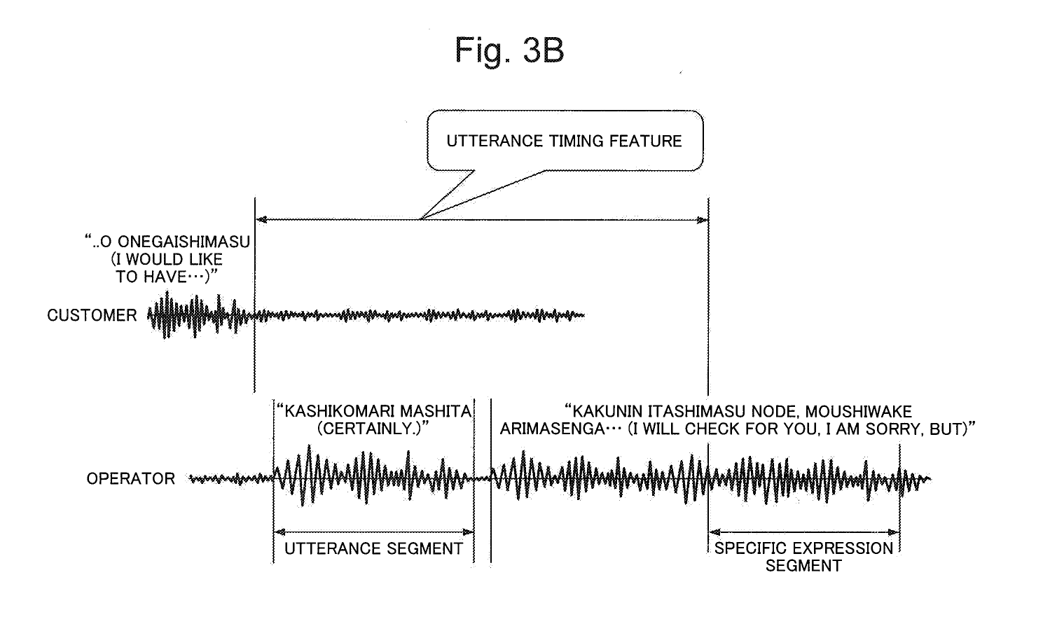

FIGS. 3A and 3B are diagrams conceptually illustrating an example of the utterance timing feature. As shown in FIG. 3A, the apologetic expression “moushiwake gozaimasen (Excuse me)” uttered by an operator with compassion for the dissatisfaction of a customer tends to be uttered immediately after the utterance in which the customer expressed dissatisfaction. In the case of FIG. 3A, the utterance timing feature that indicates a short time is extracted. On the other hand, as illustrated in FIG. 3B, the apologetic expression “moushiwake arimasen (Excuse me)” that is perfunctorily uttered by the operator tends to be uttered with a certain time interval after the utterance of the customer. In the case of FIG. 3B, the utterance timing feature that indicates a long time is extracted. In this way, in accordance with the utterance timing feature, a specific expression that has a perfunctory connotation and a specific expression that has a compassionate connotation for the dissatisfaction can be distinguished.

The classification unit 27 classifies a specific expression included in the above specific expression segment based on the nuance corresponding to the use situation in the target telephone conversation by using the feature information extracted by the feature extraction unit 26. Specifically, the classification unit 27 classifies the specific expression by giving the feature information extracted by the feature extraction unit 26 as a feature to the classifier that is provided for the specific expression set. For example, when the specific expression table 24 stores a specific expression set that indicates apology and the segment detection unit 23 detects a specific expression segment that includes an apologetic expression, the classification unit 27 uses a classifier that classifies apologetic expressions. In this case, the classifier group 28 is configured by a single classifier.

When the specific expression table 24 stores a plurality of specific expression sets that have different concepts, the classification unit 27 classifies the specific expression by selecting a classifier corresponding to the specific expression included in the specific expression segment that is detected by the segment detection unit 23 among the classifier group 28 provided for the respective specific expression sets and giving the feature information extracted by the feature extraction unit 26 as a feature to the selected classifier. For example, when the segment detection unit 23 detects a response expression, the classification unit 27 selects a classifier that classifies response expressions from among the classifier group 28 and classifies the response expression.

In the exemplary embodiment, the classification unit 27 includes a classifier group 28. The classifier group 28 is a set of classifiers, each of which is provided for each specific expression set. In other words, each classifier is specialized a corresponding specific expression set. However, as described above, there is a case in which the classifier group 28 is configured by a single classifier. Each classifier is implemented as a software element, such as a function, by the CPU 11 executing a program stored in the memory 12. The exemplary embodiment does not restrict the algorithm of each classifier. However, in the first exemplary embodiment, a classifier that performs machine-learning the respective specific expression set is exemplified. For a model that can be used as a classifier, for example, a logistic regression model or a support vector machine can be given.

The classifier of the first exemplary embodiment learns by using conversation voices for learning that include the specific expression in the following manner. Each classifier respectively learns classification information that classifies the specific expression based on at least one of a nuance obtained from other utterances around the specific expression corresponding to the classifier and a nuance obtained from a subjective evaluation of how the specific expression sounds in the conversation voice for learning, and feature information that is extracted with regard to the specific expression from the conversation voice for learning by using as learning data. Accordingly, because learning data that specifies the specific expression set corresponding to each classifier is respectively used in learning of each classifier, each classifier that learns in this way can perform highly accurate classification with a small amount of data.

However, learning of each classifier may be performed by the telephone analysis server 10 or other device. The feature information used as learning data may be acquired by giving the voice data of a conversation for learning to the telephone analysis server 10, and by the voice recognition unit 21, segment detection unit 23, and feature extraction unit 26 being executed.

<Example of Learning by Classifier>

A classifier that deals with a specific expression set indicating apologetic expressions is hereinafter referred to as a classifier of apologetic expression. The classifier of apologetic expression classifies an apologetic expression as sincere apology or not. Here, sincere apology means an apologetic expression that is uttered with compassion for the dissatisfaction of the other telephone conversation participant. In learning of apologetic expressions by the classifier, a plurality of telephone conversation data for learning, that includes an apologetic expression of an operator, such as “moushiwake gozaimasen (politeness expression which means excuse me)”, is prepared, and feature information of specific expression segments including apologetic expressions are respectively extracted from each telephone conversation data for learning. Further, whether dissatisfaction of a customer exists before the apologetic expression or not is determined by a subjective evaluation (a sensory evaluation) or an objective evaluation (an evaluation by a known automatic evaluation method), and data that indicates the determination result is generated as classification information. Then, the classifier learns the feature information and the classification information as learning data.

The classification information may be generated based on data that indicates the determination result of determining whether the voice of the apologetic expression sounds compassionate or not by a subjective evaluation (a sensory evaluation). Further, the classification information may be generated in consideration of both data that indicate whether dissatisfaction of a customer exists before the apologetic expression or not and data that indicates whether the voice of the apologetic expression sounds compassionate or not.

A classifier that deals with a specific expression set indicating response expressions is hereinafter referred to as a classifier of response expression. The classifier of response expression classifies a response expression as any one of whether a dissatisfactory emotion is included or not, whether an apologetic emotion is included or not, and whether dissatisfactory emotion is included, an apologetic emotion is included, or other cases. In learning of response expressions by the classifier, a plurality of telephone conversation data for learning, that includes response expressions of an operator and a customer, such as “hai (Yes)” and “ee (Uh-huh)”, are prepared, and feature information of the specific expression segments including the response expressions is respectively extracted from each telephone conversation data for learning. Further, whether dissatisfaction of a customer exists around a response expression of an operator and a customer or not is determined by a subjective evaluation (a sensory evaluation) or an objective evaluation (an evaluation by a known automatic evaluation method), and data that indicates the determination result is generated as classification information. Then, the classifier learns the feature information and the classification information as learning data. In this case, a response expression of a customer is classified based on the nuance of whether the customer is dissatisfied or not, and a response expression of an operator is classified based on the nuance of whether the operator is compassionate for the dissatisfaction of a customer or not. In this way, based on the relationship between the output (two values) of the classifier and the utterer of the response expression corresponding to the feature information that is input to the classifier, the response expression is classified as whether including a dissatisfactory emotion, including an apologetic emotion, or other cases.

The classification information may be generated based on data that indicates a determination result of determining whether the voice of the response expression sounds dissatisfactory, apologetic, or other cases by a subjective evaluation (a sensory evaluation). The classifier that has learned from this classification information can classify response expressions as whether including a dissatisfactory emotion, including an apologetic emotion, or other cases. Further, the classification information may be generated in consideration of both data that indicate whether dissatisfaction of a customer exists before the response expression or not and data that is obtained by a subjective evaluation of the voice of the response expression.

The output of the classification unit 27 is not necessarily two values. The classifier may output the classification result as a continuous value that indicates classification reliability. For example, when a logistic regression model is used as a classifier, the classification result is obtained as a posterior probability. Therefore, as a result of classifying the apologetic expression as sincere apology or not, continuous values that indicate that the probability of sincere apology is 0.9 and the probability of not sincere apology (a perfunctory apologetic expression) is 0.1. In the exemplary embodiment, the output by such a continuous value is also referred to as the classification result of an apologetic expression. Further, when a support vector machine is used as a classifier, a distance from an identification plain and the like may be used as a classification result.

The classification unit 27 generates output data that respectively indicates the classification result of each specific expression included in each telephone conversation and outputs the determination result to the display unit or other output devices via the input and output I/F 13. For example, the classification unit 27 may generate output data that respectively indicates the utterance segment, the specific expression segment, and the classification result (a nuance) of the specific expression with regard to the specific expression segment for each telephone conversation. The exemplary embodiment does not restrict specific output forms.

[Operation Example]

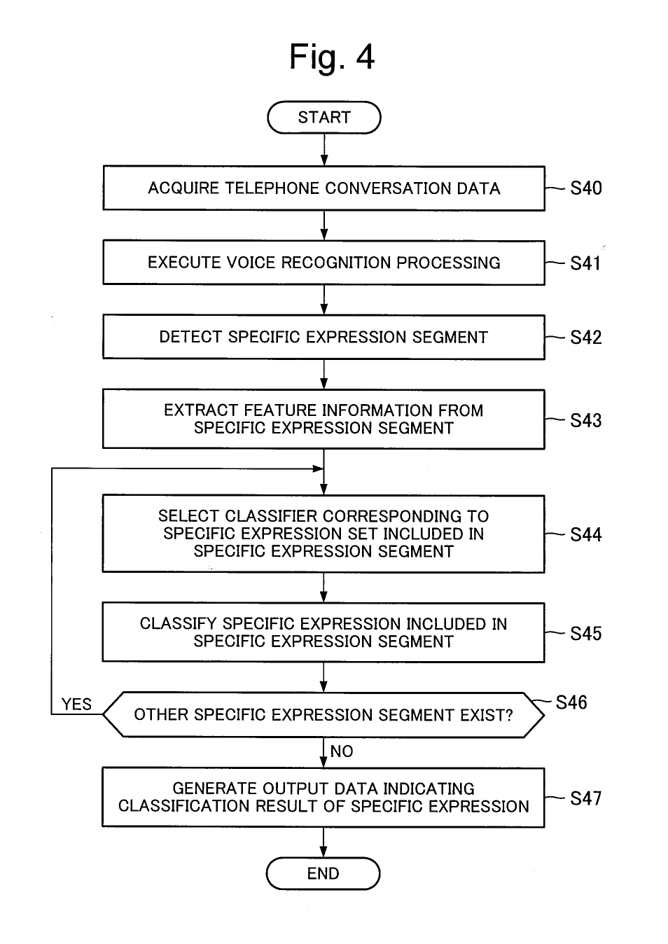

In the following, the expression classification method according to the first exemplary embodiment will be described with reference to FIG. 4. FIG. 4 is a flowchart illustrating an operation example of the telephone analysis server 10 according to the first exemplary embodiment.

The telephone analysis server 10 acquires telephone conversation data (S40). In the first exemplary embodiment, the telephone analysis server 10 acquires telephone conversation data as an analysis target from among a plurality of telephone conversation data stored in the file server 9.

The telephone analysis server 10 performs voice recognition processing to the voice data included in the telephone conversation data acquired at (S40) (S41). Accordingly, the telephone analysis server 10 acquires voice text data and utterance time data of a customer and an operator. Each voice text data is divided into words (parts of speech). Further, the utterance time data includes utterance time data for each word or each word string that is equivalent to each utterance segment.

The telephone analysis server 10 detects a specific expression that is stored in the specific expression table 24 from among the voice text data acquired at (S41), and detects the specific expression segment that includes the detected specific expression (S42). As with the detection, for example, the telephone analysis server 10 acquires the start time and end time with regard to each specific expression segment.

The telephone analysis server 10 respectively extracts feature information (S43) with regard to each specific expression segment detected at (S42). The telephone analysis server 10 extracts at least one of a prosody feature and an utterance timing feature as the feature information. The prosody feature is extracted from the voice data corresponding to the specific expression segment. The utterance timing feature is extracted, for example, based on the voice text data and utterance time data that are acquired at (S41).

The telephone analysis server 10 respectively executes (S44) and (S45) for all the specific expression segments detected at (S42). At (S44), the telephone analysis server 10 selects a classifier that corresponds to the specific expression set included in the target specific expression segment from among the classifier group 28. At (S45), the telephone analysis server 10 classifies the specific expression included in the target specific expression segment by giving the feature information that is extracted from the target specific expression segment at (S43) as a feature to the classifier. When the classifier group 28 is configured only by a single classifier, (S44) can be omitted.

When (S44) and (S45) are executed for all the specific expression segments (S46; No), the telephone analysis server 10 generates output data that respectively indicates classification results of the specific expressions in the respective specific expression segments (S47). This output data may be screen data to be displayed on the display unit, print data to be printed by a printer, or an editable data file.

[Operation and Effect of the First Exemplary Embodiment]

As described above, in the first exemplary embodiment, a classifier is provided for at least one specific expression (a specific expression set) that has the same concept, and the specific expression is classified by the classifier. Further, when a plurality of concepts are dealt with, classifiers are respectively provided each for at least one classification expression (a specific expression set) that has the same concept, a classifier corresponding to the target specific expression is selected from among such a classifier group 28, and the specific expression is classified by the classifier. Therefore, according to the first exemplary embodiment, because a classifier specialized for each unit of specific expressions is used, highly precise classification can be realized with a small amount of data (feature information) compared with a form that deals with a whole utterance and a whole expression as a classification target.

Further, in the first exemplary embodiment, classification information, that classifies a specific expression by at least one of the nuance obtained from other utterances around the corresponding specific expression and the nuance obtained by a subjective evaluation of how the voice of corresponding specific expression sounds, and feature information that is extracted with regard to the specific expression is used as learning data of each classifier. By learning that uses such learning data, a classifier that accurately classifies specific expressions based on nuances corresponding to the use situation can be realized. For example, the classifier of apologetic expression can appropriately classify an apologetic expression as sincere apology or other cases (perfunctory apology or the like).

In the first exemplary embodiment, the classifier of response expression learns using classification information for classifying response expressions based on at least one of whether the response expression sounds compassionate or not, whether the response expression sounds dissatisfactory or not, and whether dissatisfaction is shown around the response expression or not. Accordingly, a response expression is classified as any one of whether a dissatisfactory emotion is included or not, whether an apologetic emotion is included or not, and whether a dissatisfactory emotion is included, an apologetic emotion is included, or other cases. Therefore, according to the first exemplary embodiment, a response expression that is used in a variety of connotations can be appropriately classified based on the nuance.

### Second Exemplary Embodiment

The second exemplary embodiment determines whether a target telephone conversation is a dissatisfactory telephone conversation or not by using the classification result of the specific expression in the first exemplary embodiment. Hereinafter, a contact center system 1 according to the second exemplary embodiment will be described primarily on a content that is different from the first exemplary embodiment. In the following description, the same content as the first exemplary embodiment will be omitted as necessary.

[Processing Configuration]

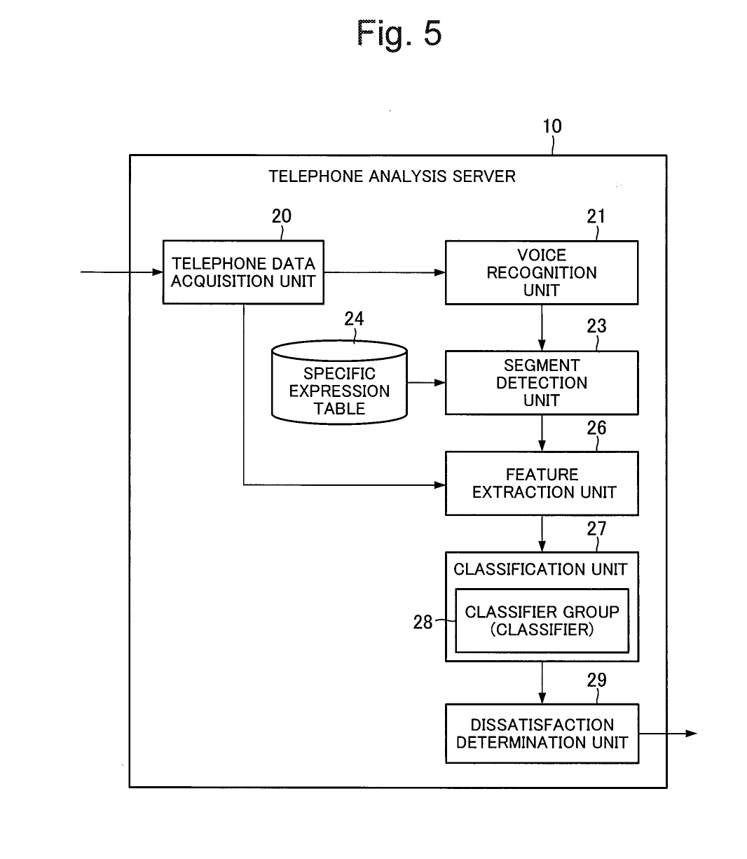

FIG. 5 is a diagram conceptually illustrating a processing configuration example of the telephone analysis server 10 according to the second exemplary embodiment. The telephone analysis server 10 according to the second exemplary embodiment further includes a dissatisfaction determination unit 29 in addition to the components of the first exemplary embodiment. As with the other processing units, the dissatisfaction determination unit 29 is implemented, for example, by the CPU 11 executing a program stored in the memory 12.

When an apologetic expression is classified as sincere apology or a response expression is classified as including a dissatisfactory emotion or an apologetic emotion, the dissatisfaction determination unit 29 determines that the telephone conversation that includes such an apologetic expression or response expression as a dissatisfaction telephone conversation. The reason that an operator utters an apologetic expression that indicates sincere apology or a response expression that includes an apologetic emotion is because the customer expresses dissatisfaction in the telephone conversation. The reason that a customer utters a response expression that includes a dissatisfactory emotion is because the customer feels dissatisfaction in the telephone conversation.

When the classification result of a specific expression can be obtained in a continuous value, the dissatisfaction determination unit 29 may output the detection result as a continuous value that indicates the degree of dissatisfaction instead of as the presence or absence of dissatisfaction.

The dissatisfaction determination unit 29 generates output data that indicates the determination result of determining whether or not each telephone conversation data is a dissatisfaction telephone conversation with regard to each telephone conversation, and outputs the determination result to the display unit or other output devices via the input and output I/F 13. For example, the dissatisfaction determination unit 29 may generate output data that indicates the utterance segment, the specific expression segment, the classification result (a nuance) of the specific expression with regard to the specific expression segment, and data that indicates whether the telephone conversation is a dissatisfaction telephone conversation or not for each telephone conversation. The exemplary embodiment does not restrict specific output forms.

[Operation Example]

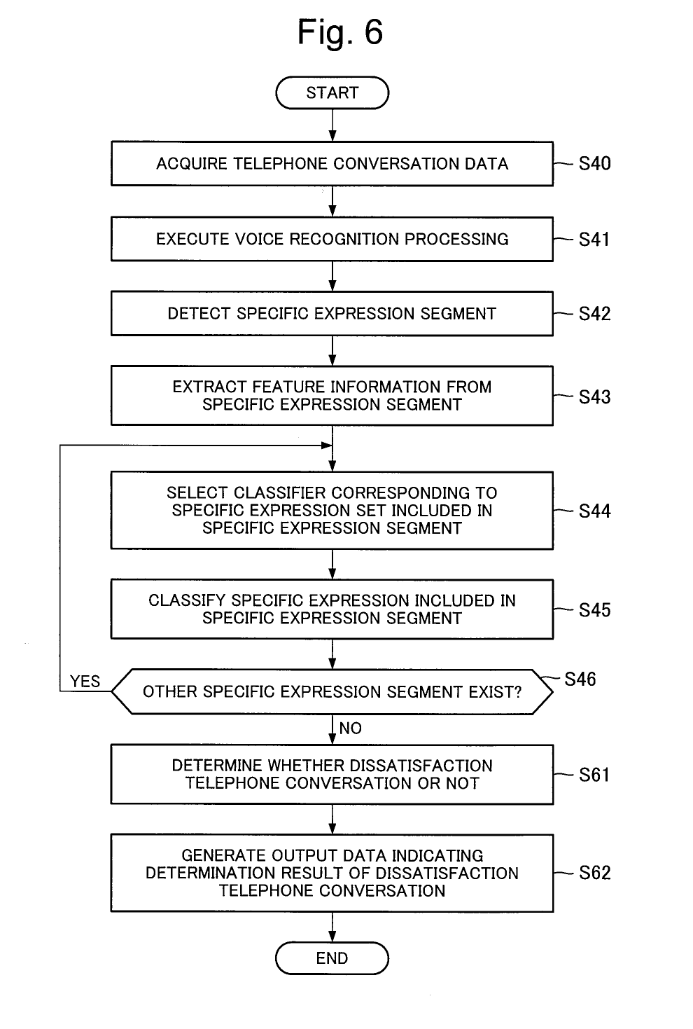

Hereinafter, a dissatisfaction detection method according to the second exemplary embodiment will be described with reference to FIG. 6. FIG. 6 is a flowchart illustrating an operation example of the telephone analysis server 10 according to the second exemplary embodiment. In FIG. 6, the same processes as those of FIG. 4 are assigned the same signs as in FIG. 4.

The telephone analysis server 10 determines whether a telephone conversation that is indicated by telephone conversation data acquired at (S40) is a dissatisfaction telephone conversation or not based on the result of classification at (S45) with regard to each specific expression segment (S61). Specifically, as described above, when an apologetic expression is classified as sincere apology or a response expression is classified as including a dissatisfactory emotion or an apologetic emotion, the telephone analysis server 10 determines that the telephone conversation that includes such an apologetic expression or response expression as a dissatisfaction telephone conversation.

The telephone analysis server 10 generates output data that indicates the result of determining that the telephone conversation indicated by the telephone conversation data acquired at (S40) is a dissatisfaction telephone conversation (S62). As described above, when the classifier group 28 is configured only by a single classifier, (S44) can be omitted.

[Operation and Effect of the Second Exemplary Embodiment]

As described above, in the second exemplary embodiment, whether the target telephone conversation is a dissatisfaction telephone conversation or not is determined based on the result of classification by the nuance of the specific expression according to the first exemplary embodiment. Thus, according to the second exemplary embodiment, even if a telephone conversation includes an apologetic expression that is used in a plurality of connotations, such as sincere apology and perfunctory apology, the emotional state (dissatisfactory state) of the telephone conversation participant can be extracted with high precision by reading the nuance of the expression from the telephone conversation data. Further, according to the second exemplary embodiment, because a nuance of whether a dissatisfactory emotion is included or an apologetic emotion is included can be read even from a response expression that does not have a specific connotation in itself, whether the conversation is a dissatisfaction telephone conversation or not can be appropriately determined from the response expression.

[Variation]

The telephone analysis server 10 as described above may also be implemented by a plurality of computers. In such a case, for example, the telephone analysis server 10 includes only the classification unit 27 and the dissatisfaction determination unit 29, and other computer includes the other processing units. The above-described telephone analysis server 10 includes the classifier group 28. However, the classifier group 28 may be implemented on other computer. In such a case, the classification unit 27 sends feature information to the classifier group 28 that is implemented on the other computer and retrieves the classification result of the classifier group 28.

FIGS. 4 and 6 illustrate that following processes are performed after feature information is extracted from all specific expression segments at (S43). However, (S43), (S44), and (S45) may be executed for each specific expression segment.

### Other Exemplary Embodiments

While telephone conversation data is used in the above-described exemplary embodiments and variation, the above-described expression classification device and expression classification method may be adapted in a device and system that deals with conversation data other than telephone conversations. In such a case, for example, a record device that records conversations as analysis targets is installed at a place where the conversations takes place (e.g., a meeting room, a teller counter at a bank, a cash register at a store). Alternatively, when the conversation data is recorded in a state where voices of a plurality of conversation participants are mixed, the voice data of each conversation participant can be separated from the mixed state by predetermined voice processing.

The whole or part of the exemplary embodiments disclosed above can be described as, but not limited to, the following supplementary notes.

(Supplementary Note 1)

An expression classification device includes:

a segment detection unit that detects a specific expression segment that includes a specific expression that can be used in a plurality of nuances from data corresponding to a voice of a conversation;

a feature extraction unit that extracts feature information that includes at least one of a prosody feature and an utterance timing feature with regard to the specific expression segment that is detected by the segment detection unit; and

a classification unit that classifies the specific expression included in the specific expression segment based on a nuance corresponding to a use situation in the conversation by using the feature information extracted by the feature extraction unit.

(Supplementary Note 2)

The expression classification device according to supplementary note 1, wherein

the classification unit classifies the specific expression included in the specific expression segment by giving the feature information that is extracted by the feature extraction unit to a classifier that classifies a plurality of specific expressions that have a same concept based on the nuance.

(Supplementary Note 3)

The expression classification device according to supplementary note 2, wherein

the classifier learns classification information that classifies the specific expression, based on at least one of a nuance obtained from other utterances around the specific expression corresponding to the classifier and a nuance obtained from a subjective evaluation of how the specific expression sounds in a conversation voice for learning, and the feature information that is extracted with regard to the specific expression from the conversation voice for learning by using as learning data.

(Supplementary Note 4)

The expression classification device according to any one of supplementary notes 1 to 3, wherein

the classification unit classifies the specific expression by selecting a classifier corresponding to the specific expression included in the specific expression segment from among a plurality of classifiers, each of which is provided for at least one of the specific expression that has the same concept, and giving the feature information extracted by the feature extraction unit to the selected classifier.

(Supplementary Note 5)

The expression classification device according to any one of supplementary notes 2 to 4, wherein

the specific expression is an apologetic expression,

the classification unit classifies the apologetic expression as either sincere apology or not, and

the classifier corresponding to the apologetic expression learns classification information that classifies the apologetic expression, based on at least one of whether the apologetic expression in the conversation voice for learning sounds compassionate or not and whether dissatisfaction is shown before the apologetic expression or not, and the feature information that is extracted with regard to the apologetic expression from the conversation voice for learning by using as learning data.

(Supplementary Note 6)

The expression classification device according to any one of supplementary notes 2 to 5, wherein

the specific expression is a response expression,

the classification unit classifies the response expression as any one of whether a dissatisfactory emotion is included or not, whether an apologetic emotion is included or not, and whether dissatisfactory emotion is included, an apologetic emotion is included, or other cases,

the classifier corresponding to the response expression learns classification information that classifies the response expression, based on at least one of whether the response expression in a conversation voice for learning sounds compassionate or not, whether the response expression sounds dissatisfactory or not, and whether dissatisfaction is shown around the response expression or not, and the feature information that is extracted with regard to the response expression from the conversation voice for learning by using as learning data.

(Supplementary Note 7)

A dissatisfaction detection device includes:

the expression classification device according to supplementary note 5 or 6; and

a dissatisfaction determination unit that determines the conversation that includes the apologetic expression or the response expression as a dissatisfaction conversation when the apologetic expression is classified as sincere apology or the response expression is classified as including a dissatisfactory emotion or an apologetic emotion by the classification unit of the expression classification device.

(Supplementary Note 8)

An expression classification method that is executed by at least one computer, includes:

detecting a specific expression segment that includes a specific expression that can be used in a plurality of nuances from data corresponding to a voice of a conversation;

extracting feature information that includes at least one of a prosody feature and an utterance timing feature with regard to the detected specific expression segment; and

classifying the specific expression included in the specific expression segment based on a nuance corresponding to a use situation in the conversation by using the extracted feature information.

(Supplementary Note 9)

The expression classification method according to supplementary note 8, wherein

the classifying classifies the specific expression included in the specific expression segment by giving the extracted feature information to a classifier that classifies a plurality of specific expressions that have a same concept based on the nuance.

(Supplementary Note 10)

The expression classification method according to supplementary note 9, further includes:

causing the classifier to learn classification information that classifies the specific expression, based on at least one of a nuance obtained from other utterances around the specific expression corresponding to the classifier and a nuance obtained from a subjective evaluation of how the specific expression sounds in a conversation voice for learning, and the feature information that is extracted with regard to the specific expression from the conversation voice for learning by using as learning data.

(Supplementary Note 11)

The expression classification method according to any one of supplementary notes 8 to 10, further includes:

selecting a classifier corresponding to the specific expression included in the specific expression segment from among a plurality of classifiers, each of which is provided for at least one of the specific expression that has the same concept, wherein

the classifying classifies the specific expression by giving the extracted feature information to the selected classifier.

(Supplementary Note 12)

The expression classification method according to any one of supplementary notes 9 to 11, wherein

the specific expression is an apologetic expression,

further includes:

the classifying classifies the apologetic expression as either sincere apology or not; and

causing the classifier corresponding to the apologetic expression to learn classification information that classifies the apologetic expression, based on at least one of whether the apologetic expression in the conversation voice for learning sounds compassionate or not and whether dissatisfaction is shown before the apologetic expression or not, and the feature information that is extracted with regard to the apologetic expression from the conversation voice for learning by using as learning data.

(Supplementary Note 13)

The expression classification method according to any one of supplementary notes 9 to 12, wherein

the specific expression is a response expression, and

the classifying classifies the response expression as any one of whether a dissatisfactory emotion is included or not, whether an apologetic emotion is included or not, and whether a dissatisfactory emotion is included, an apologetic emotion is included, or other cases,

the method further includes:

causing the classifier corresponding to the response expression to learn classification information that classifies the response expression, based on at least one of whether the response expression in a conversation voice for learning sounds compassionate or not, whether the response expression sounds dissatisfactory or not, and whether dissatisfaction is shown around the response expression or not, and the feature information that is extracted with regard to the response expression from the conversation voice for learning by using as learning data.

(Supplementary Note 14)

A dissatisfaction detection method includes:

the expression classification method according to supplementary note 12 or 13 and

being executed by the at least one computer,

further includes:

determining the conversation that includes the apologetic expression or the response expression as a dissatisfaction conversation when the apologetic expression is classified as sincere apology or the response expression is classified as including a dissatisfactory emotion or an apologetic emotion.

(Supplementary Note 15)

A program that causes at least one computer to execute the expression classification method according to any one of supplementary notes 8 to 13 or the dissatisfaction detection method according to supplementary note 14.

(Supplementary Note 16)

A computer readable medium records the program according to supplementary note 15.

This application is based upon and claims the benefit of priority from Japanese patent application No. 2012-240765, filed on Oct. 31, 2012, the disclosure of which is incorporated herein in its entirety by reference.

What is claimed is:

1. An expression classification device comprising:
a segment detection unit that detects a specific expression segment that includes a specific expression that can be used in a plurality of nuances from data corresponding to a voice of a conversation;
a feature extraction unit that extracts feature information that includes at least one of a prosody feature and an utterance timing feature with regard to the specific expression segment that is detected by the segment detection unit; and
a classification unit that classifies the specific expression included in the specific expression segment based on a nuance corresponding to a use situation in the conversation by using the feature information extracted by the feature extraction unit.

2. The expression classification device according to claim 1, wherein
the classification unit classifies the specific expression included in the specific expression segment by giving the feature information that is extracted by the feature extraction unit to a classifier that classifies at least one of specific expressions that have a same concept based on the nuance.

3. The expression classification device according to claim 2, wherein
the classifier learns classification information that classifies the specific expression, based on at least one of a nuance obtained from other utterances around the specific expression corresponding to the classifier and a nuance obtained from a subjective evaluation of how the specific expression sounds in a conversation voice for learning, and the feature information that is extracted with regard to the specific expression from the conversation voice for learning by using as learning data.

4. The expression classification device according to claim 1, wherein
the classification unit classifies the specific expression by selecting a classifier corresponding to the specific expression included in the specific expression segment from among a plurality of classifiers, each of which is provided for at least one of the specific expression that has the same concept, and giving the feature information extracted by the feature extraction unit to the selected classifier.

5. The expression classification device according to claim 2, wherein
the specific expression is an apologetic expression,
the classification unit classifies the apologetic expression as either sincere apology or not, and
the classifier corresponding to the apologetic expression learns classification information that classifies the apologetic expression, based on at least one of whether the apologetic expression in the conversation voice for learning sounds compassionate or not and whether dissatisfaction is shown before the apologetic expression or not, and the feature information that is extracted with regard to the apologetic expression from the conversation voice for learning by using as learning data.

6. The expression classification device according to claim 2, wherein
the specific expression is a response expression,
the classification unit classifies the response expression as any one of whether a dissatisfactory emotion is included or not, whether an apologetic emotion is included or not, and whether dissatisfactory emotion is included, an apologetic emotion is included, or other cases,
the classifier corresponding to the response expression learns classification information that classifies the response expression, based on at least one of whether the response expression in a conversation voice for learning sounds compassionate or not, whether the response expression sounds dissatisfactory or not, and whether dissatisfaction is shown around the response expression or not, and the feature information that is extracted with regard to the response expression from the conversation voice for learning by using as learning data.

7. A dissatisfaction detection device comprising:
the expression classification device according to claim 5; and
a dissatisfaction determination unit that determines the conversation that includes the apologetic expression or the response expression as a dissatisfaction conversation when the apologetic expression is classified as sincere apology or the response expression is classified as including a dissatisfactory emotion or an apologetic emotion by the classification unit of the expression classification device.

8. An expression classification method that is executed by at least one computer that comprising: a CPU; and a memory that is connected with the CPU, the method comprising:
detecting a specific expression segment that includes a specific expression that can be used in a plurality of nuances from data corresponding to a voice of a conversation;
extracting feature information that includes at least one of a prosody feature and an utterance timing feature with regard to the detected specific expression segment; and
classifying the specific expression included in the specific expression segment based on a nuance corresponding to a use situation in the conversation by using the extracted feature information.

9. The expression classification method according to claim 8, wherein
the classifying classifies the specific expression included in the specific expression segment by giving the extracted feature information to a classifier that classifies a plurality of specific expressions that have a same concept based on the nuance.

10. The expression classification method according to claim 9, further comprising:
causing the classifier to learn classification information that classifies the specific expression, based on at least one of a nuance obtained from other utterances around the specific expression corresponding to the classifier and a nuance obtained from a subjective evaluation of how the specific expression sounds in a conversation voice for learning, and the feature information that is extracted with regard to the specific expression from the conversation voice for learning by using as learning data.

11. The expression classification method according to claim 8, further comprising:
selecting a classifier corresponding to the specific expression included in the specific expression segment from among a plurality of classifiers, each of which is provided for at least one of the specific expression that has the same concept, wherein
the classifying classifies the specific expression by giving the extracted feature information to the selected classifier.

12. The expression classification method according to claim 9, wherein
the specific expression is an apologetic expression,
further comprising:
the classifying classifies the apologetic expression as either sincere apology or not; and
causing the classifier corresponding to the apologetic expression to learn classification information that classifies the apologetic expression, based on at least one of whether the apologetic expression in the conversation voice for learning sounds compassionate or not and whether dissatisfaction is shown before the apologetic expression or not, and the feature information that is extracted with regard to the apologetic expression from the conversation voice for learning by using as learning data.

13. The expression classification method according to claim 9, wherein
the specific expression is a response expression, and
the classifying classifies the response expression as any one of whether a dissatisfactory emotion is included or not, whether an apologetic emotion is included or not, and whether a dissatisfactory emotion is included, an apologetic emotion is included, or other cases,
the method further comprising:
causing the classifier corresponding to the response expression to learn classification information that classifies the response expression, based on at least one of whether the response expression in a conversation voice for learning sounds compassionate or not, whether the response expression sounds dissatisfactory or not, and whether dissatisfaction is shown around the response expression or not, and the feature information that is extracted with regard to the response expression from the conversation voice for learning by using as learning data.

14. A dissatisfaction detection method comprising:
the expression classification method according to claim 12 and
being executed by the at least one computer,
further comprising:
determining the conversation that includes the apologetic expression or the response expression as a dissatisfaction conversation when the apologetic expression is classified as sincere apology or the response expression is classified as including a dissatisfactory emotion or an apologetic emotion.

15. A computer readable non-transitory medium embodying a program, the program causing at least one computer to perform the expression classification method according to claim 8.

16. An expression classification device comprising:
segment detection means for detecting a specific expression segment that includes a specific expression that can be used in a plurality of nuances from data corresponding to a voice of a conversation;
feature extraction means for extracting feature information that includes at least one of a prosody feature and an utterance timing feature with regard to the specific expression segment that is detected by the segment detection unit; and
classification means for classifying the specific expression included in the specific expression segment based on a nuance corresponding to a use situation in the conversation by using the feature information extracted by the feature extraction unit.
